(19) United States
(12) Patent Application Publication
(10) Pub. No.: US 2016/0234636 A1
(43) Pub. Date: Aug. 11, 2016

(54) APPARATUSES AND METHODS FOR PROVIDING CELL INFORMATION IN SECURE USER PLANE LOCATION (SUPL) MESSAGES

(71) Applicant: MediaTek Inc., Hsin-Chu (TW)

(72) Inventors: Ching-Liang CHANG, New Taipei City (TW); Ying-Lung WANG, New Taipei City (TW); Che-jen KUO, Taipei City (TW)

(21) Appl. No.: 14/974,272

(22) Filed: Dec. 18, 2015

Related U.S. Application Data
(60) Provisional application No. 62/114,260, filed on Feb. 10, 2015.

(51) Int. Cl. H04W 4/02

(52) U.S. Cl. CPC H04W 4/02

(57) ABSTRACT

A mobile communication device including a wireless transceiver and a processor is provided. The wireless transceiver is configured to perform wireless transmission and reception to and from an advanced network and a legacy network. The processor is configured to perform a Secure User Plane Location (SUPL) session with a SUPL server when the mobile communication device is camped on the advanced network, and transmit a SUPL message including cell information of the legacy network to the SUPL server via the wireless transceiver in response to performing the SUPL session with the SUPL server.

### CROSS REFERENCE TO RELATED APPLICATIONS

This application claims priority of U.S. Provisional Application No. 62/114,260, filed on Feb. 10, 2015, the entirety of which is incorporated by reference herein.

### BACKGROUND OF THE INVENTION

1. Field of the Invention

The invention generally relates to location service technologies, and more particularly, to apparatuses and methods for providing cell information in Secure User Plane Location (SUPL) messages.

2. Description of the Related Art

Applications related to Location Based Services (LBS) are becoming more and more popular in today's mobile markets. For mobile subscribers, using LBS-related applications on mobile communication devices requires the user's location to be available as quickly and accurately as possible. Although the Global Positioning System (GPS) has been the main solution to this need for several years, it has its limitations. Generally, GPS works fine in rural areas but often barely works in urban area or in buildings. Thus, it is commonly proposed to supplement the GPS with assistance and positioning data provided by the networks (also called the Assisted-GPS (A-GPS)). The assistance and positioning data can be exchanged between the mobile communication devices and the networks over either the control plane or the user plane. A control plane implementation uses a dedicated control channel, and this approach has been used for emergency services, such as the E911 mandate in the United States. However, it results in significant network overhead, due to the software and hardware changes needed for various network components to support the location-specific messages. To this end, the user plane implementations have grown in popularity in recent years for non-critical commercial location applications.

As one of the user plane implementations, the Secure User Plane Location (SUPL) was developed by the Open Mobile Alliance (OMA) to support the LBS for mobile communications in various cellular technologies, such as the Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA2000) technology, Time Division-Synchronous Code Division Multiple Access (TD-SCDMA) technology, Worldwide Interoperability for Microwave Access (WiMAX) technology, Long Term Evolution (LTE) technology, Time-Division LTE (TD-LTE) technology, LTE-Advanced (LTE-A) technology, etc. In the A-GPS infrastructure implementing the SUPL protocol, a mobile communication device transmits information of the cell on which it currently camps to a SUPL server, and the SUPL server determines the reference location corresponding to the cell information and then replies to the mobile communication device with the reference location, the reference time, and the ephemeris. After that, the mobile communication device uses the assistance data to speed up the GPS Time To First Fix (TTFF) process.

However, in an advanced network, such as an LTE network, the cell deployment may be still in progress and the SUPL server may not have the most updated cell information of the advanced network. As a result, the SUPL server may provide inaccurate assistance data for a cell of the advanced network, and the GPS TTFF process may be seriously delayed due to using inaccurate assistance data.

### BRIEF SUMMARY OF THE INVENTION

In an embodiment, a mobile communication device comprising a wireless transceiver and a processor is provided. The wireless transceiver is configured to perform wireless transmission and reception to and from an advanced network and a legacy network. The processor is configured to perform a Secure User Plane Location (SUPL) session with a SUPL server when the mobile communication device is camped on the advanced network, and transmit a SUPL message comprising cell information of the legacy network to the SUPL server via the wireless transceiver in response to performing the SUPL session with the SUPL server.

In another embodiment, a method executed by a mobile communication device to provide cell information in a SUPL message is provided. The method comprises the steps of: performing a SUPL session with a SUPL server when the mobile communication device is camped on an advanced network; and transmitting a SUPL message comprising cell information of a legacy network to the SUPL server in response to performing the SUPL session with the SUPL server.

Other aspects and features of the present invention will become apparent to those with ordinarily skill in the art upon review of the following descriptions of specific embodiments of the mobile communication devices and the methods for providing cell information in a SUPL message.

### BRIEF DESCRIPTION OF DRAWINGS

The application can be more fully understood by reading the subsequent detailed description and examples with references made to the accompanying drawings, wherein:

FIG. 1 is a block diagram illustrating a wireless communications environment according to an embodiment of the application;

FIG. 2 is a block diagram illustrating the mobile communication device 110 according to an embodiment of the application;

FIG. 3 is a flow chart illustrating the method for a mobile communication device to provide cell information in a SUPL message according to an embodiment of the application;

FIG. 4 is a message sequence chart illustrating the provision of cell information in a SUPL message according to the embodiment of FIG. 3;

FIG. 5 is a flow chart illustrating the method for a mobile communication device to provide cell information in a SUPL message according to another embodiment of the application; and

FIG. 6 is a message sequence chart illustrating the provision of cell information in a SUPL message according to the embodiment of FIG. 5.

### DETAILED DESCRIPTION OF THE INVENTION

This description is made for the purpose of illustrating the general principles of the application and should not be taken in a limiting sense. It should be understood that the embodiments may be realized in software, hardware, firmware, or any combination thereof.

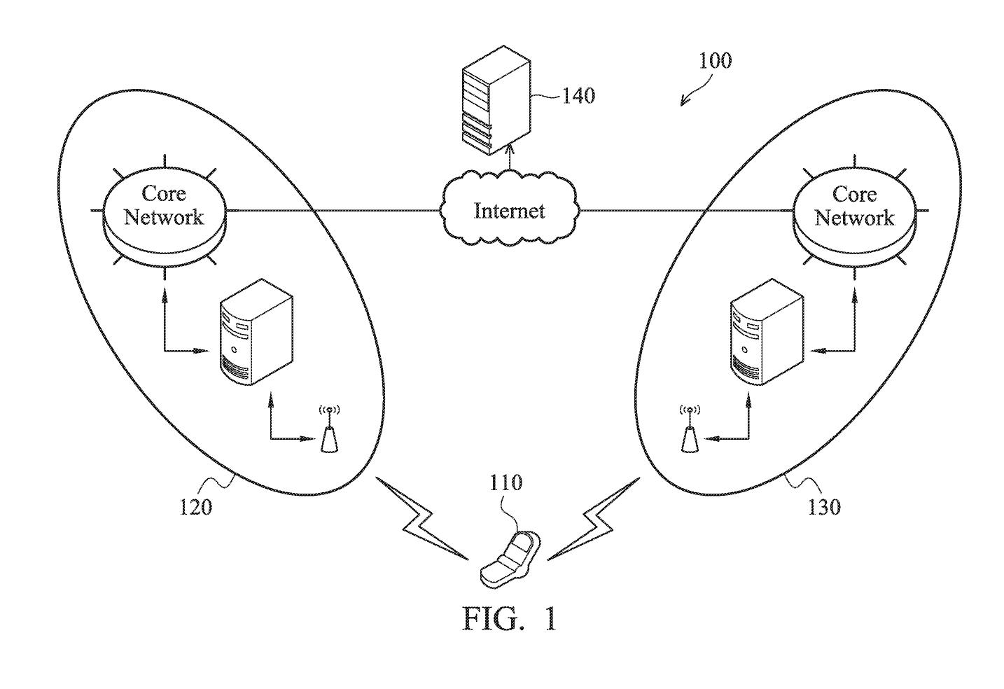

FIG. 1 is a block diagram illustrating a wireless communications environment according to an embodiment of the application. The wireless communications environment 100 may comprise a mobile communication device 110, at least two service networks 120 and 130, and a SUPL server 140. The mobile communication device 110 may be a mobile phone, panel PC, notebook PC, tablet, wearable device, or any portable computing device supporting the cellular technologies utilized by the service networks 120 and 130. Alternatively, the mobile communication device 110 may be an external data card for a computer host, notebook, or panel PC to obtain mobile services. The mobile communication device 110 may wirelessly communicate with one or both of the service networks 120 and 130 for obtaining mobile services, including Circuit-Switched (CS) and/or Packet-Switched (PS) services, wherein the CS services may include voice call services, and Short Message Service (SMS), etc., and the PS services may include Voice over IP (VoIP) service and data services, such as e-mail transmission, web browsing, file upload/download, instant messaging, streaming video, etc. In addition, the mobile communication device 110 may be configured to support SUPL transactions with the SUPL server 140 to obtain assistance data for LBS. The mobile communication device 110 may connect to the Internet, through the service network 120 or 130, or another connection network (e.g., Wireless Local Area Network (WLAN)), for communicating with the SUPL server 140.

Each of the service networks 120 and 130 may support a respective cellular technology. In this embodiment, service network 120 may be an advanced network and service network 130 may be a legacy network. For example, service network 120 may be a 3rd Generation Partnership Project (3GPP) 4th Generation (4G) network, such as an LTE, LTE-A, or TD-LTE network, while service network 130 may be a 3GPP 2nd Generation (2G) network, such as a GSM, GPRS, or EDGE network, or a 3GPP 3rd Generation (3G) network, such as a WCDMA network. Alternatively, service network 120 may be a 3GPP 5th Generation (5G), 6th Generation (6G), or 7th Generation (7G) network, while service network 130 may be a 3GPP 2G, 3G, or 4G network.

The service networks 120 and 130 may each comprise an access network and a core network. Using the service network 120 being an LTE/LTE-A/TD-LTE network as an example, the access network may be an Evolved-Universal Terrestrial Radio Access Network (E-UTRAN) which includes at least an evolved NB (eNB), and the core network may be an Evolved Packet Core (EPC) which includes at least a Home Subscriber Server (HSS), Mobility Management Entity (MME), Serving Gateway (S-GW), Packet Data Network Gateway (PDN-GW or P-GW). Using the service network 130 being a WCDMA network as an example, the access network may be a Universal Terrestrial Radio Access Network (UTRAN) which includes at least a Node B and a Radio Network Controller (RNC), and the core network may be a GPRS core which includes at least a Home Location Register (HLR), at least one Serving GPRS Support Node (SGSN), at least one Gateway GPRS Support Node (GGSN). Alternatively, using the service network 130 being a GSM/GPRS/EDGE network as an example, the access network may be a Base Station Subsystem (BSS) which includes at least a Base Transceiver Station (BTS) and a Base Station Controller (BSC), and the core network may be a GPRS core.

The SUPL server 140 may be a third-party server host (e.g., a Google SUPL server) connected to the Internet, which may handle tasks associated with user authentication, location requests, location-based application downloads, charging, and/or roaming. Specifically, the SUPL server 140 may provide GPS assistance data for SUPL Enabled Terminals (SETs), such as the mobile communication device 110. In one embodiment, the SUPL server 140 may maintain a database for storing the mapping between cell information and assistance data, including reference time, reference location (e.g., latitude and longitude), ephemeris, or a combination thereof.

In another embodiment, the SUPL server 140 may be a private network equipment in the service network 120 or 130. For example, the SUPL server 140 may be setup by the operator of the service network 120 or 130, and only accessible to the mobile subscribers of the service network 120 or 130.

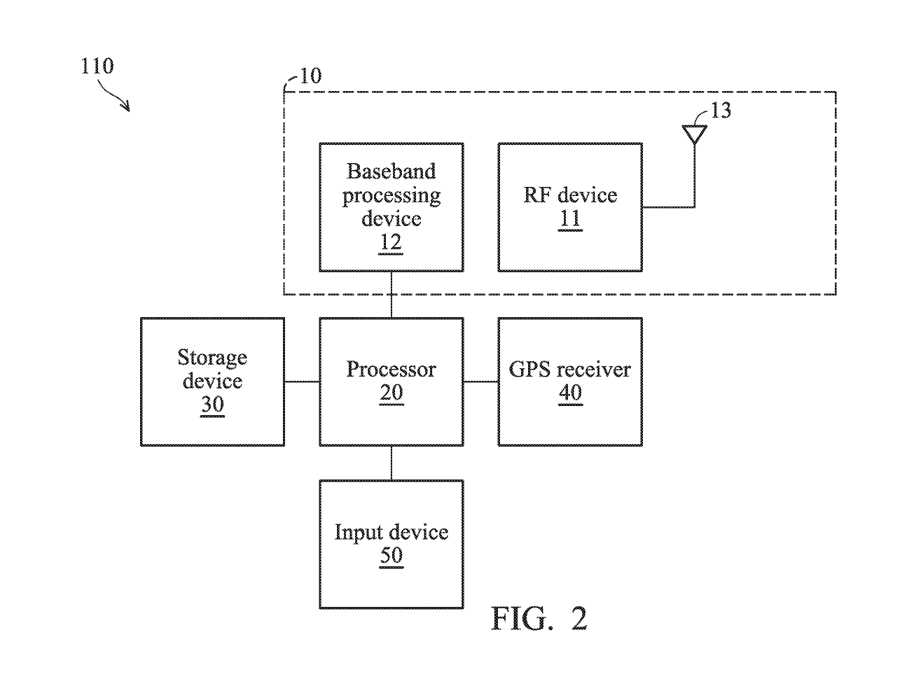

FIG. 2 is a block diagram illustrating the mobile communication device 110 according to an embodiment of the application. The mobile communication device 110 may comprise a wireless transceiver 10 and a processor 20. In some embodiments, the mobile communication device 110 may further comprise a storage device 30, a GPS receiver 40, and an input device 50. The wireless transceiver 10 may be configured to perform wireless transmission and reception to and from the service networks 120 and 130. The wireless transceiver 10 may comprise a Radio Frequency (RF) device 11, a baseband processing device 12, and an antenna 13. The baseband processing device 12 may be configured to perform baseband signal processing and control the communications between the subscriber identity card(s) and the RF device 11. The baseband processing device 12 may further contain other hardware components to perform the baseband signal processing, including Analog-to-Digital Conversion (ADC)/Digital-to-Analog Conversion (DAC), gain adjusting, modulation/demodulation, encoding/decoding, and so on. The RF device 11 may receive RF wireless signals via the antenna 13, convert the received RF wireless signals to baseband signals, which are processed by the baseband processing device 12, or receive baseband signals from the baseband processing device 12 and convert the received baseband signals to RF wireless signals, which are later transmitted via the antenna 13. The RF device 11 may also contain multiple hardware devices to perform radio frequency conversion. For example, the RF device 10 may comprise a mixer to multiply the baseband signals with a carrier oscillated in the radio frequency of the supported cellular technologies, wherein the radio frequency may be 900 MHz, 1800 MHz or 1900 MHz utilized in GSM/GPRS/EDGE technology, or may be 900 MHz, 1900 MHz or 2100 MHz utilized in WCDMA technology, or may be 900 MHz, 2100 MHz, or 2.6 GHz utilized in LTE/LTE-A/TD-LTE technology, or another radio frequency, depending on the cellular technology in use. In one example, the wireless transceiver 10 may include one set of RF device 11, baseband processing device 12 and antenna 13 suitable for communication via both of the service networks 120 and 130. In another example, the wireless transceiver 10 may include one set of RF device 11, baseband processing device 12 and antenna 13 suitable for communication via the service network 120, and another set of RF device 11, baseband processing device 12 and antenna 13 suitable for communication via the service network 130. In still another example, the wireless transceiver 10 may include one baseband processing device 12 suitable for communication via both of the service networks 120 and 130, one set of RF device 11 and antenna 13 suitable for communication via the service network 120 and another set of RF device 11 and antenna 13 suitable for communication via the service network 130. However, the above examples are for illustrative purpose only, the implementation of the wireless transceiver 10 may vary according to different design requirements while still falls within the scope of the invention.

The processor 20 may be a general-purpose processor, a Micro Control Unit (MCU), an application processor, a Digital Signal Processor (DSP), or the like, for controlling the wireless transceiver 10 for wireless communications with the service networks 120 and 130, storing and retrieving data to and from the storage device 30, controlling the GPS receiver 40 for obtaining location information, receiving signals from the input device 50. In one embodiment, the processor 20 may coordinate the aforementioned operations of the wireless transceiver 10 and the storage device 30 for performing the method for providing cell information in a SUPL message.

In another embodiment, the processor 20 may be integrated with the baseband processing device 12, serving as a baseband processor.

The storage device 30 may be a memory, such as a volatile memory or a Non-volatile Memory, or a magnetic storage device, such as a hard disk or a magnetic tape, or an optical disc, or any combination thereof for storing cell information of one or more legacy networks (e.g., the service network 130) and instructions and/or program code of applications and/or communication protocols.

The GPS receiver 40 may be configured to provide location information of the mobile communication device 110. By locking on to a constellation of satellites orbiting the earth, the GPS receiver 40 can pinpoint the exact position (including latitude, longitude, and/or altitude) of the mobile communication device 110 on the planet, calculate the speed and direction in which the mobile communication device 110 is moving. The GPS receiver 40 may comprise a L-band radio processor capable of solving the navigation equations in order to determine the position of the mobile communication device 110, velocity and precise time (PVT), by processing the signal broadcasted by GPS satellites.

The input device 50 may comprise one or more buttons, a keyboard, a mouse, a touch pad, a video camera, a microphone, and/or a speaker, etc., serving as the Man-Machine Interface (MMI) for interaction with users.

It should be understood that the components described in the embodiment of FIG. 2 are for illustrative purposes only and are not intended to limit the scope of the application.

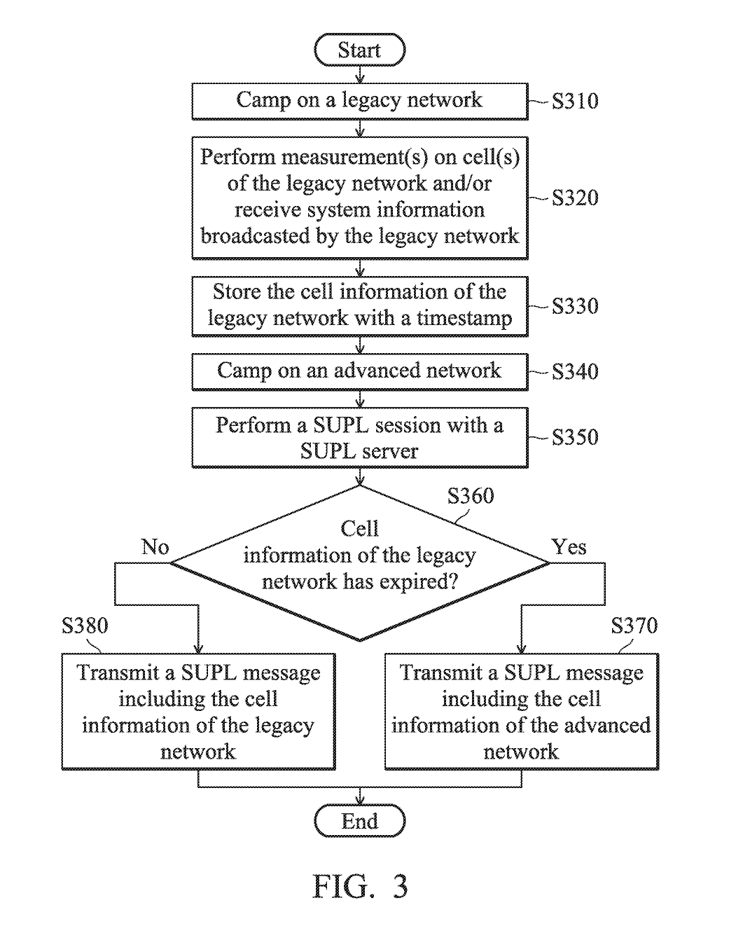

FIG. 3 is a flow chart illustrating the method for a mobile communication device to provide cell information in a SUPL message according to an embodiment of the application. The steps may not be required to be executed in the exact order shown in FIG. 3. In addition, certain steps may be added to or removed from the flow shown in FIG. 3, depending upon actual design considerations. The mobile communication device may camp on a legacy network (step S310). When camped on the legacy network, the mobile communication device may perform one or more measurements on one or more cells of the legacy network and/or receive system information broadcasted by the legacy network (step S320). The mobile communication device may store the cell information of the legacy network, which may be obtained from the measurement(s) and/or from the system information broadcasted by the legacy network, with a timestamp (step S330). The timestamp may be used to mark the time when the cell information is obtained. In one embodiment, the cell information may include the cell information of the serving cell and optionally the cell information of the neighbor cell(s).

In one embodiment, the cell information may include at least one of a Mobile Country Code (MCC), a Mobile Network Code (MNC), a Location Area Code (LAC), and a GSM Cell Identity (CID), if the legacy network is a GSM/GPRS/EDGE network.

In another embodiment, the cell information may include at least one of an MCC, an MNC, an LAC, and a Universal Cell ID (UCID), if the legacy network is a WCDMA network.

Subsequently, the mobile communication device may camp on an advanced network (step S340). When camped on the advanced network, the mobile communication device may perform a SUPL session with a SUPL server (step S350). In one embodiment, the SUPL session may be performed in response to being triggered by the advanced network (i.e., the SUPL session is a network-initiated SUPL session) or by an LBS application (i.e., the SUPL session is an SET-initiated SUPL session) which is executed in the mobile communication device.

In response to performing the SUPL session, the mobile communication device may determine whether the cell information of the legacy network has expired (step S360). In one embodiment, the timestamp may be used to check if a predetermined period of time (e.g., 5 minutes) since the cell information was obtained has elapsed, and if not, the cell information of the legacy network may be determined to have not yet expired. Otherwise, if the predetermined period of time since the cell information was obtained has elapsed, the cell information of the legacy network may be determined to have expired.

In response to the cell information of the legacy network not having expired, the mobile communication device may transmit a SUPL message including the cell information of the legacy network to the SUPL server (step S370).

In response to the cell information of the legacy network having expired, the mobile communication device may transmit a SUPL message including the cell information of the advanced network to the SUPL server (step S380). In one embodiment, the cell information of the advanced network may be obtained during the process of the mobile communication device camping on the advanced network. For example, the cell information of the advanced network may include the cell information of the serving cell in the advanced network.

The SUPL messages in step S370 and S380 may each be a SUPL_START message, a SUPL_POS_INIT message, a SUPL_TRIGGERED_START message, a SUPL_POS message, or a combination thereof. For a SUPL_POS message, the cell information may be placed in the Radio Resource LCS (LoCation Service) Protocol (RRLP) payload or in the LTE Positioning Protocol (LPP) payload.

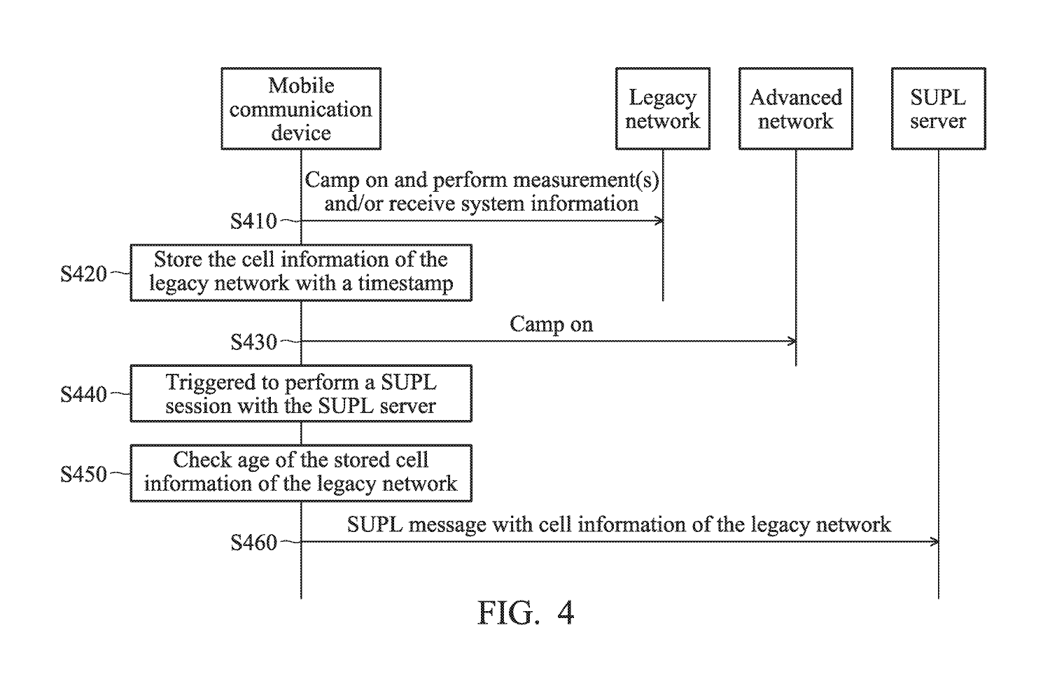

FIG. 4 is a message sequence chart illustrating the provision of cell information in a SUPL message according to the embodiment of FIG. 3. The mobile communication device may camp on the legacy network and perform one or more measurements on one or more cells of the legacy network and/or receive system information broadcasted by the legacy network (step S410). The mobile communication device may store the cell information of the legacy network, which may be obtained from the one or more measurements and/or from the system information broadcasted by the legacy network, with a timestamp (step S420).

Subsequently, the mobile communication device may camp on the advanced network (step S430). The mobile communication device may be triggered to perform a SUPL session with the SUPL server (step S440). In one embodiment, the mobile communication device may be triggered by the advanced network or by an LBS application which is executed in the mobile communication device.

In response to performing the SUPL session, the mobile communication device may check if the age of the cell information of the legacy network is within a predetermined period of time (step S450). In this embodiment, it is assumed that the age of the cell information of the legacy network is within the predetermined period of time, so the mobile communication device may transmit a SUPL message including the cell information of the legacy network to the SUPL server (step S460).

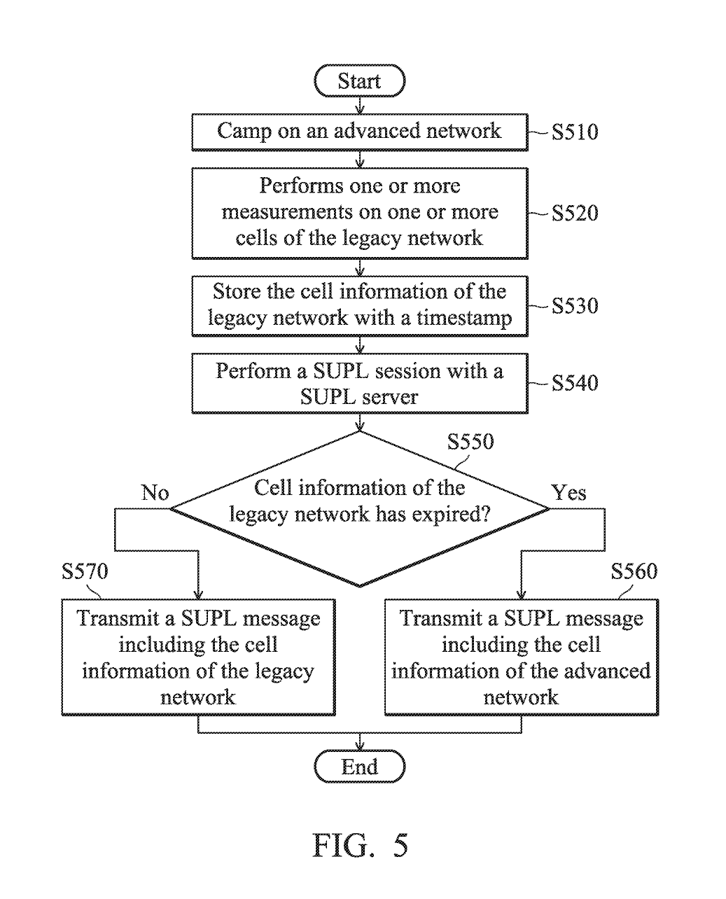

FIG. 5 is a flow chart illustrating the method for a mobile communication device to provide cell information in a SUPL message according to another embodiment of the application. The steps may not be required to be executed in the exact order shown in FIG. 5. In addition, certain steps may be added to or removed from the flow shown in FIG. 5, depending upon actual design considerations. The mobile communication device may camp on an advanced network (step S510). The mobile communication device may perform one or more measurements on one or more cells of the legacy network (step S520).

In one embodiment, the measurement(s) may be performed when the mobile communication device is configured to operate in the IDLE mode or any operation mode as long as the one or more measurements will not impede other tasks that the mobile communication device is configured to handle in the same mode.

In another embodiment, the measurement(s) may be performed when the mobile communication device is camped on a Closed Subscriber Group (CSG) cell in the advanced network. The measurement(s) may be performed according to the neighbor cell information obtained from the CSG cell.

The mobile communication device may store the cell information of the legacy network, which may be obtained from the one or more measurements, with a timestamp (step S530). The timestamp may be used to mark the time when the cell information is obtained from the one or more measurements. In one embodiment, the cell information may include the cell information of the neighbor cell(s) that belong to the legacy network.

Similar to the embodiment of FIG. 3, the cell information may include at least one of an MCC, an MNC, an LAC, and a CID, if the legacy network is a GSM/GPRS/EDGE network. Alternatively, the cell information may include at least one of an MCC, an MNC, an LAC, and a UCID, if the legacy network is a WCDMA network.

The mobile communication device may perform a SUPL session with a SUPL server (step S540). In one embodiment, the SUPL session may be performed in response to being triggered by the advanced network (i.e., the SUPL session is a network-initiated SUPL session) or by an LBS application which is executed in the mobile communication device (i.e., the SUPL session is an SET-initiated SUPL session).

In response to performing the SUPL session, the mobile communication device may determine whether the cell information of the legacy network has expired (step S550). In one embodiment, the timestamp may be used to check if a predetermined period of time (e.g., 5 minutes) since the cell information was obtained has elapsed, and if not, the cell information of the legacy network may be determined to have not yet expired. Otherwise, if the predetermined period of time since the cell information was obtained has elapsed, the cell information of the legacy network may be determined to have expired.

In response to the cell information of the legacy network not having expired, the mobile communication device may transmit a SUPL message including the cell information of the legacy network to the SUPL server (step S560).

In response to the cell information of the legacy network having expired, the mobile communication device may transmit a SUPL message including the cell information of the advanced network to the SUPL server (step S570). In one embodiment, the cell information of the advanced network may be obtained during the process of the mobile communication device camping on the advanced network. For example, the cell information of the advanced network may include the cell information of the serving cell (if the serving cell is a non-CSG cell) and/or the cell information of the neighboring non-CSG cell(s) (if the serving cell is a CSG cell) in the advanced network. In one embodiment, the cell information may include at least one of an MCC, an MNC, a Tracking Area Code (TAC), a Cell ID (CID), and a Physical Cell Identity (PCI), if the advanced network is an LTE/LTE-A/TD-LTE network.

Similar to the embodiment of FIG. 3, the SUPL messages in step S560 and S570 may each be a SUPL_START message, a SUPL_POS_INIT message, a SUPL_TRIGGERED_START message, a SUPL_POS message, or a combination thereof. For a SUPL_POS message, the cell information may be placed in the RRLP payload or in the LPP payload.

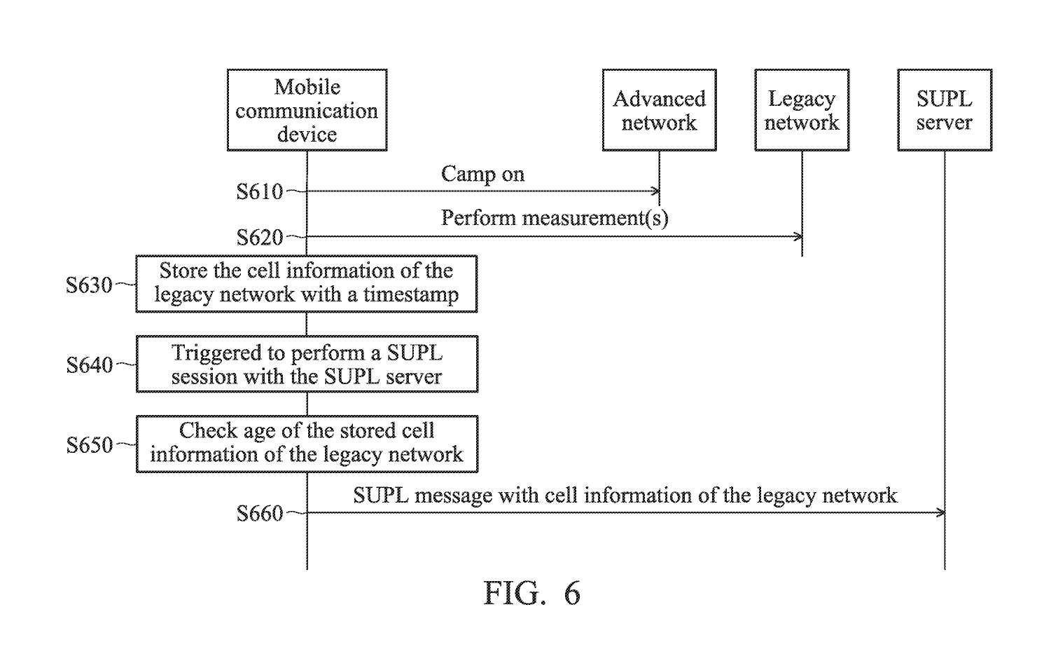

FIG. 6 is a message sequence chart illustrating the provision of cell information in a SUPL message according to the embodiment of FIG. 5. The mobile communication device may camp on the advanced network (step S610). When camped on the advanced network, the mobile communication device may perform one or more measurements on one or more cells of the legacy network (step S620).

The mobile communication device may store the cell information of the legacy network, which may be obtained from the one or more measurements, with a timestamp (step S630). The mobile communication device may be triggered to perform a SUPL session with the SUPL server (step S640). In one embodiment, the mobile communication device may be triggered by the advanced network or by an LBS application which is executed in the mobile communication device.

In response to performing the SUPL session, the mobile communication device may check if the age of the cell information of the legacy network is within a predetermined period of time (step S650). In this embodiment, it is assumed that the age of the cell information of the legacy network is within the predetermined period of time, so the mobile communication device may transmit a SUPL message including the cell information of the legacy network to the SUPL server (step S660).

While the invention has been described by way of example and in terms of preferred embodiment, it is to be understood that the invention is not limited thereto. Those who are skilled in this technology can still make various alterations and modifications without departing from the scope and spirit of this invention. For example, if the cellular technology evolves beyond 4G, the method for providing cell information in a SUPL message may still be applied to a wireless communications environment in which the legacy network is a 3GPP 2G/3G/4G network and the advanced network is a 3GPP 5G/6G/7G network. Therefore, the scope of the present invention shall be defined and protected by the following claims and their equivalents.

What is claimed is:

1. A mobile communication device, comprising:
a wireless transceiver, configured to perform wireless transmission and reception to and from an advanced network and a legacy network; and
a processor, configured to perform a Secure User Plane Location (SUPL) session with a SUPL server when the mobile communication device is camped on the advanced network, and transmit a SUPL message comprising cell information of the legacy network to the SUPL server via the wireless transceiver in response to performing the SUPL session with the SUPL server.

2. The mobile communication device of claim 1, wherein, prior to the mobile communication device camping on the advanced network, the processor is further configured to perform a measurement on a cell of the legacy network and/or receive system information broadcasted by the legacy network when the mobile communication device was camped on the legacy network, so as to obtain the cell information of the legacy network.

3. The mobile communication device of claim 2, wherein the processor is further configured to determine whether a predetermined period of time since the cell information was obtained has elapsed in response to performing the SUPL session with the SUPL server, and transmit another SUPL message comprising cell information of the advanced network to the SUPL server via the wireless transceiver in response to the predetermined period of time since the cell information was obtained having elapsed, and the transmission of the SUPL message comprising the cell information of the legacy network to the SUPL server is performed in response to the predetermined period of time since the cell information was obtained not having elapsed.

4. The mobile communication device of claim 1, wherein the processor is further configured to perform a measurement on a cell of the legacy network via the wireless transceiver when the mobile communication device is camped on the advanced network, so as to obtain the cell information of the legacy network.

5. The mobile communication device of claim 4, wherein the processor is further configured to determine whether a predetermined period of time since the cell information was obtained has elapsed in response to performing the SUPL session with the SUPL server, and transmit another SUPL message comprising cell information of the advanced network to the SUPL server via the wireless transceiver in response to the predetermined period of time since the cell information was obtained having elapsed, and the transmission of the SUPL message comprising the cell information of the legacy network to the SUPL server is performed in response to the predetermined period of time since the cell information was obtained not having elapsed.

6. The mobile communication device of claim 4, wherein the measurement is performed when the mobile communication device is configured to operate in an IDLE mode with the advanced network.

7. The mobile communication device of claim 4, wherein the mobile communication device is camped on a Closed Subscriber Group (CSG) cell of the advanced network, and the measurement is performed according to neighbor cell information obtained from the CSG cell.

8. The mobile communication device of claim 1, wherein the SUPL session is performed in response to being triggered by the advanced network or by a Location-Based Service (LBS) application executed in the mobile communication device.

9. The mobile communication device of claim 1, wherein the advanced network is a 3rd Generation Partnership Project (3GPP) 4th Generation (4G) network, and the legacy network is a 3GPP 2nd Generation (2G) network or a 3GPP 3rd Generation (3G) network.

10. The mobile communication device of claim 1, wherein the SUPL message is a SUPL_START message, a SUPL_POS_INIT message, a SUPL_TRIGGERED_START message, a SUPL_POS message, or a combination thereof.

11. A method executed by a processor of a mobile communication device to provide cell information in a Secure User Plane Location (SUPL) message, the method comprising:
performing a SUPL session with a SUPL server when the mobile communication device is camped on an advanced network; and
transmitting a SUPL message comprising cell information of a legacy network to the SUPL server in response to performing the SUPL session with the SUPL server.

12. The method of claim 11, further comprising:
prior to the mobile communication device camping on the advanced network, performing a measurement on a cell of the legacy network and/or receiving system information broadcasted by the legacy network when the mobile communication device was camped on the legacy network, so as to obtain the cell information of the legacy network.

13. The method of claim 12, further comprising:
determining whether a predetermined period of time since the cell information was obtained has elapsed in response to performing the SUPL session with the SUPL server; and
transmitting another SUPL message comprising cell information of the advanced network to the SUPL server in response to the predetermined period of time since the cell information was obtained having elapsed,
wherein the transmission of the SUPL message comprising the cell information of the legacy network to the SUPL server is performed in response to the predetermined period of time since the cell information was obtained not having elapsed.

14. The method of claim 11, further comprising:
performing a measurement on a cell of the legacy network when the mobile communication device is camped on the advanced network, so as to obtain the cell information of the legacy network.

15. The method of claim 14, further comprising:
determining whether a predetermined period of time since the cell information was obtained has elapsed in response to performing the SUPL session with the SUPL server; and
transmitting another SUPL message comprising cell information of the advanced network to the SUPL server in response to the predetermined period of time since the cell information was obtained having elapsed,
wherein the transmission of the SUPL message comprising the cell information of the legacy network to the SUPL server is performed in response to the predetermined period of time since the cell information was obtained not having elapsed.

16. The method of claim 14, wherein the measurement is performed when the mobile communication device is configured to operate in an IDLE mode with the advanced network.

17. The method of claim 14, wherein the mobile communication device is camped on a Closed Subscriber Group (CSG) cell of the advanced network, and the measurement is performed according to neighbor cell information obtained from the CSG cell.

18. The method of claim 11, wherein the SUPL session is performed in response to being triggered by the advanced network or by a Location-Based Service (LBS) application executed in the mobile communication device.

19. The method of claim 11, wherein the SUPL message is a SUPL_START message, a SUPL_POS_INIT message, a SUPL_TRIGGERED_START message, a SUPL_POS message, or a combination thereof.

20. The method of claim 11, wherein the advanced network is a 3rd Generation Partnership Project (3GPP) 4th Generation (4G) network, and the legacy network is a 3GPP 2nd Generation (2G) network or a 3GPP 3rd Generation (3G) network.
